(19) United States
(12) Patent Application Publication
(10) Pub. No.: US 2004/0145601 A1
(43) Pub. Date: Jul. 29, 2004

(54) Method and a device for providing additional functionality to a separate application

(75) Inventors: Miriam Silke Brielmann, Pliezhausen (DE); Wolfgang Bloem, Holzgerlingen (DE); Ulrike Grzemba, Boeblingen (DE)

Correspondence Address: Marilyn Smith Dawkins, International Business Machines Corporation, Intellectual Property Law Department, 11400 Burnet Road, Austin, TX, 78758, US

(73) Assignee: International Business Machines Corporation, Armonk, NY

(21) Appl. No.: 10/460,420

(22) Filed: Jun. 12, 2003

(30) Foreign Application Priority Data
Jan. 29, 2003 (DE) 02015494.4

(51) Int. Cl. G09G 5/00

(52) U.S. Cl. 345/708; 345/705

(57) ABSTRACT

Method and a device is provided for providing additional functionality to a separate application. A first interface for monitoring the state of the application and a second interface for intercepting the user's input to the application are provided between the device and the application, furthermore, a repository for keeping rules specifying additional functionality, such as assistance to be presented to the user, in response to the state of the application and/or the user's input, means for triggering one of the rules, and means for providing assistance and/or an application enhancement to the user as specified in the triggered rule. The rule may be triggered by a user's input and/or a particular state of the application and the device provides the additional functionality, e.g., presenting the assistance and/or the application enhancement relevant to the input and/or state. Finally, the device includes means for inputting data into the separate application, whereby the data is derived from the intercepted user's input and/or the state of the application. The application does not need to provide any additional interface for the device.

### BACKGROUND OF THE INVENTION

1. Field of the Invention

The present invention generally relates to the enhancement of an existing application running on a computer system. Particularly, the present invention relates to a method and system for providing additional functionality to a separate application running on a computer system. Additional functionality may also be formed by providing proactively and dynamically context sensitive assistance, e.g., visual, aural and/or textual information, to a user of a computer program system, undertaking the user's role in controlling an application, or enhancing the functionality of a separate application.

2. Description of the Related Art

Today, most applications utilizing windows have at least three disparate ways to deliver help: First, the user can select a help menu item from a window's menu bar; second, the user can press a help button in a dialog window; and third, the user can cause hover help to be displayed when a mouse event occurs over a Graphical User Interface (GUI) control, i.e., the user pauses the mouse over a GUI control for a predetermined length of time.

Such prior systems fail to provide standardized context sensitive user assistance, which is both dynamic and proactive. This problem is especially significant in Java™ applications, where there is not currently a standard for context sensitive help. Such prior systems also rely on hard coded identifiers to call up the various user help views, where the code for user help is integrated with the application code.

U.S. Pat. No. 6,300,950 by David J. Clark et.al., assigned to International Business Machines Corporation, filed Apr. 2, 1998, issued Oct. 9, 2001, “Presentation Of Help Information Via a Computer System User Interface In Response To User Interaction” shows a framework supporting presentation of help information via a computer system user interface in response to the proximity of an input device pointer to an interface area associated with a user interface component. The framework provides generic methods, which remove from user interface components much of the task of managing the presentation of help information. The framework supports presentation of help information for a platform-independent component programming environment and supports presentations in a plurality of different styles by means of selectable presentation methods.

U.S. Pat. No. 5,933,139 by Randall James Feigner et.al., assigned to Microsoft Corporation, Redmond, Wash. (US), filed Jan. 31, 1997, issued Aug. 3, 1999, “Method And Apparatus For Creating Help Functions” provides a computer implemented method of creating a context-sensitive help function in a computer's software application, wherein the context-sensitive help function is made part of the computer software application.

U.S. Pat. No. 6,208,338 by Marin Fischer et.al., assigned to Hewlett-Packard Company, Palo Alto, Calif. (US), filed May 15, 1998, issued Mar. 27, 2001, “Online Documentation And Help System For Computer-Based Systems” shows an integrated online information system including an online help engine for requesting and receiving a documentation and/or help information, an address database for storing addresses of the documentation and/or help information, and a browser for receiving the documentation and/or help information in a network architecture corresponding to an address applied to the browser.

U.S. Pat. No. 5,155,806 by Anthony Hoeber et.al, assigned to Sun Microsystem, Inc., Mountain View, Calif. (US), filed Dec. 29, 1989, issued Oct. 13, 1992, “Method And Apparatus For Displaying Context Sensitive Help Information on a Display” teaches that the selection of certain buttons results in the generation and display of a menu which includes a plurality of functions which may be chosen by a user. Help information may be obtained by a user by positioning the pointer on the display using the pointer control device over an area of the window which the user desires the help information. After placing the pointer over a desired area, which may include by way of example an icon, window function, or other window image, the user depresses a predefined help keep on a keyboard coupled to the CPU. The CPU then locates a help description, which corresponds the object or area over which the pointer has been placed. The CPU displays then an image of the selected area and the appropriate help description within a help window.

U.S. Pat. No. 5,546,521 by Anthony E. Martinez, assigned to International Business Machines Corporation, Armonk, N.Y. (US), filed Oct. 17, 1994, issued Aug. 13, 1996, “Dynamic Presentation of Contextual Help and Status Information” provides a method and apparatus of displaying contextual help or status information to the user of a computer system in a graphical user interface. When help facility is enabled, the system determines the position of a pointer, such as a mouse pointer, relative to the objects in the graphical user interface. If the pointer is over an object, the system refers to one or more tables, which correlate objects with help and/or status information. The information is then displayed proximate to the pointer, preferably in a semitransparent window at a predictable offset from the pointer to allow the information presented by the graphical user interface to be viewed. As the pointer is moved across the graphical user interface, the information text associated with the pointer changes dynamically. In one preferred embodiment, at least one of the tables, which correlate objects with the information, is updated to reflect details about objects, which change dynamically.

U.S. Pat. No. 6,219,047 by John Bell, filed Sep. 17, 1998, issued Apr. 17, 2001, “Training Agent” presents methods and apparatus for providing tutorial information for a computer program application through a training agent activated by a user of the application. The agent takes control of the application interface and performs actions, such as finding and displaying tutorial information, in response to application user interface commands. The relation between the user interface commands and the actions is stored in a database used by the agent.

U.S. Pat. No. 6,307,544 by Andrew R. Harding, assigned to International Business Machines Corporation, Armonk, N.Y. (US), filed Jul. 23, 1998, “Method and Apparatus for Delivering a Dynamic Context Sensitive Integrated User Assistance Solution” provides a navigation model that integrates help information, task guide information, interactive wizard information or other user assistance information, e.g., into a single user assistance system. Additionally, code for the user assistance system is maintained separately from code for an application program for the computer system.

Current online help systems rarely make use of their knowledge on the current state of the system they describe. Although they are mostly part of the main application, they behave like a different application, giving context-free verbal help in a separated help browser.

### OBJECT OF THE INVENTION

Starting from this, the object of the present invention is to provide a method and a device for providing additional functionality, such as proactive assistance, to a user of a separate application running on a computer system.

### BRIEF SUMMARY OF THE INVENTION

The foregoing object is achieved by a method and a system as laid out in the independent claims. Further advantageous embodiments of the present invention are described in the sub claims and are taught in the following description.

According to the present invention a method and a device is provided for providing additional functionality to a user of a separate application running on a computer system. A first interface for monitoring the state of the application and a second interface for intercepting the user's input to the application are provided between the device and the application. It is acknowledged that both interfaces may be formed by the same technical or functional unit, such as a windowing unit, i.e., a unit, which takes care of displaying graphical objects to the user and intercepting a user's input. The device further comprises a repository for keeping rules specifying the additional functionality to be provided to the user in response to at least one of the input parameters of the group of, the state of the application, the user's input, an event triggered by said device, means for triggering one of the rules, and means for providing the assistance/information/application enhancement to the user as specified in the triggered rule. The rule may be triggered by a user's input and/or a particular state of the application and the device presents the assistance/information/application enhancement relevant to the input and/or state. Finally, the device includes means for inputting data into the separate application, whereby the data is derived from the intercepted user's input and/or the state of the application.

The additional functionality provided to the user may be formed by providing data, such as default data, to the separate application requested from said user, by extracting information from said separate application for later use, by triggering an event after a predetermined amount of time.

Such means advantageously allow controlling the application independent from a correct or timely input provided by the user. Conventional online help is displayed in a help browser, giving verbal information. This information is linked by hyperlinks, which lead to different text entities. The help is independent from the state of the application. The online help and the application are completely separated, although they mostly belong to the same program. The assistance, such as the help information, according to the present invention, however, depends on the system state and can be displayed directly in the application.

The present invention advantageously provides a solution for each kind of interaction problem with the user and the application. Interaction problems either happen because the user does not know how to tell the system what s/he wants to do or because of a wrong user model of the system. For both cases the device and method according to the present invention has got a solution.

In addition, supernumerary functionality can be provided within a separate application.

A first mode provides assistance to a user who has explicit questions. The user can trigger assistance explicitly in the online help browser, i.e., a window displayed parallel to the application windows.

A second mode provides help without being asked to explain what the user has to do to make inactive actions work. It is forced by a user interaction in the application, e.g. a user error.

In order to provide specific help, complex interaction tasks are divided into atomic interaction tasks. An atomic interaction task can be fulfilled by perhaps entering data and one confirming mouse click. Help information shows the user directly in the application window where to enter data or where to click. Advantageously, the help information may even be entered into the respective input fields of the application. Context-free (atomic) interaction tasks are distinguished from context-sensitive (atomic) interaction tasks. Context-free interaction tasks are independent from the state of the application, i.e., they can be executed in any case. Each time the user triggers the device for a context-free task s/he gets the same information. In contrary, the availability of context-sensitive interaction tasks depends on the system state. The information, which is displayed for a context-sensitive interaction task depends on the system state.

In a preferred embodiment of the present invention the online help text contains controls. If the user clicks a control s/he activates assistance. Thereby several implementations may be possible.

In contrast to the user required online help, the application may trigger assistance by an erroneous user action. E.g., if the user tries to initiate an action, which is not possible in this system state, the device according to the present invention indicates what the user has to do in order to achieve the system state, which allows the desired action. Advantageously, the device may control the application to lead the user to the desired dialog or system state.

### BRIEF DESCRIPTION OF THE SEVERAL VIEWS OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a block diagram illustrating components of a system in which the device according to the present invention can be used; and

FIG. 2 shows a flow chart illustrating how an active assistance action is triggered by a separate application.

### DETAILED DESCRIPTION OF THE INVENTION

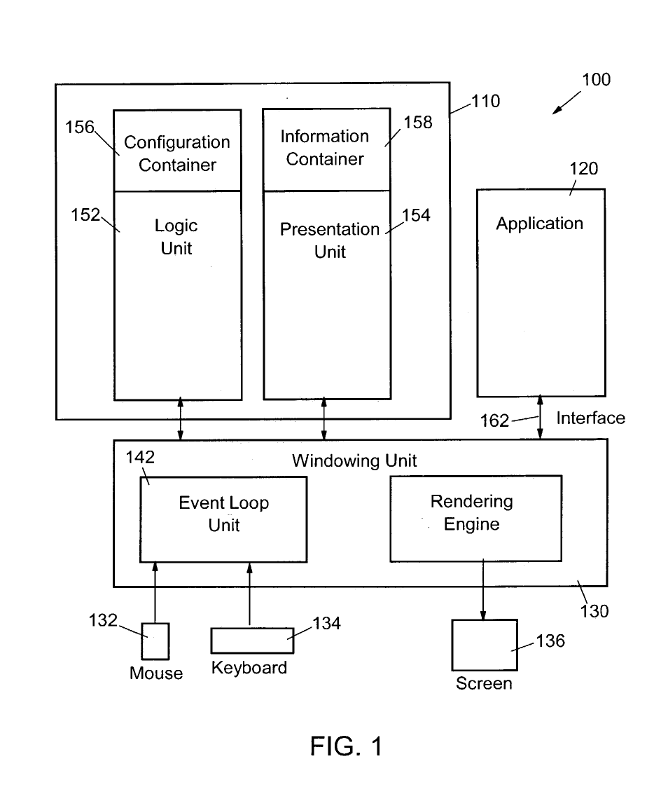

With reference to FIG. 1, there is depicted a block diagram illustrating components of a system 100, in which a device for providing additional functionality to a user of a separate application (device 110) according to the present invention can be used. The system 100 comprises an application 120, a windowing unit 130 and means for communicating between a user (not shown) and the windowing unit 130, namely, a mouse 132, a keyboard 134 and a screen 136.

As aforementioned, the present invention provides additional functionality to a user of a separate application.

An example for such additional functionality is the insertion of a “Default” button in said application. When the user clicks this button, the default values are inserted into input fields and boxes of a window. In general, the device is able to add a GUI element to the application window without altering the application code. The function of such an element is described using rules.

Similarly, values that have been entered by the user at other places of the application or even in another application can be extracted, and stored into a repository. Later on these values can be retrieved, combined and inserted into a required input field in the appropriate syntax. Examples for this are frequently used URLs, server or printer names or the like.

Analogous, a help text can contain user input or data, which is extracted from an application. Prior help systems used to provide abstract and static descriptions or help information only. However, this device is able to create dynamic help information based on rules, processing the constantly changing states of the application windows.

The integration of a watchdog timer is a further example for the provision of additional functionality in a separate application. When a specified time is elapsed without user input, specified values are automatically entered into the application.

The mouse 132 and the keyboard 134, by way of example, represent any kind of input device, such as a track ball, a touch screen or even an interface providing voice recognition and voice control units (not shown).

The screen 136 functions as an output device to which the output of the application 120 and the output of the device 110 are rendered. It should be noted that any other kind of output device capable of communicating information to the user could replace the screen, such as an acoustical transducer.

The windowing unit 130 provides an interface for applications, such as the application 120 and the device 110, to access input and output devices for communicating with a user. The application 120 uses the windowing unit 130 to locate objects on the screen 136 to form a graphical user interface and to accept the user's input via the mouse 132 or the keyboard 134. Besides the aforementioned tasks the device 110 uses the windowing unit furthermore for determining the visual state of the application 120, for monitoring and intercepting the communication between the application 120 and the user (not shown) and for communication with the application 120 itself, i.e., the device 110 is able to provide the same information to the application like the user is requested to do. In other words, the device 110 is able to control the application 120 in place of the user. This may especially be useful for autonomic computing.

Furthermore, the windowing unit 130 includes an event loop unit 142 and a rendering engine 144. The event loop unit 142 is equipped with a communicational link to the mouse 132 and the keyboard 134 or any other input devices for receiving the user's input. The event loop unit 142 notifies all applications and devices about received user input that are registered for listening. In the present case, the event loop unit 142 delivers the user input to the applications 120 and the device 110. The rendering engine 144 displays the output of the application 120 and/or the device 110 on the screen 136 by converting a high-level object-based description into a graphical image for display.

The application 120 is running on a computer system (not shown) and it is separate from the device 110, i.e., the application 120 does not need to be modified, in order to be combined with the device 110. However, if desired, a start script or some lines of the application's code may be provided in order to facilitate that the device 110 is started whenever the application 120 is launched. It should be acknowledged that such kind of interlinking the application 120 and the device 110 does not make both being one and the same application.

The device 110 comprises a logic unit 152 and a presentation unit 154. The logic unit 152 comprises a configuration container 156 for storing assistance configuration data provided by a user or a technical author. It specifies the functional behavior of the logic unit 152. The presentation unit 154 includes an information container 158 for storing online help texts to be displayed to the user by the windowing unit 130 and assistance control commands for controlling the logic unit 152, the windowing unit 130 and the application 120.

The assistance configuration data specifies, e.g., the type of assistance to be provided dependent on screen objects' states, such as, ‘visible’, ‘not visible’, ‘enabled’, ‘disabled’, ‘not existent’, ‘with input focus’ or ‘without input focus’. A file, a database table or any other form of storing structured information may form the configuration container 156.

The logic unit 152 is configured to be activated by one or more of the following components, the application 120, the windowing unit 130, the presentation unit 154 and the assistance control commands kept in the information container 158. When activated, the logic unit 152 contacts the event loop unit 142 of the windowing unit 130 and requests to be notified about the user's input. This step is also referred to as ‘registering’ with the event loop unit 142. Furthermore, the logic unit 152 evaluates the assistance configuration data stored in the configuration container 156 and utilizes the windowing unit 130, in particular, the interface 162 located between the windowing unit 130 and the application 120, to explore and evaluate the state of the application's objects displayed by the windowing unit 130. From the information retrieved from this source and the data stored in the information container 158, the logic unit derives what information and/or function to display and/or action to perform.

Consequently, the windowing unit 130 is used to control the application 120 by automatically inputting data specified in the configuration container 156 into input controls of the application that are displayed to the user by the windowing unit 130. Thus, the device 110 may supply input, which from the application's point of view would be required to be provided by the user. Alternatively or additionally, the presentation unit 154 displays online help text and/or additional functionality to the user by utilizing the windowing unit 130.

In other words, in order to proactively provide help texts, to automatically control the application's behavior, and to provide functional enhancements to the application the user or technical author provides assistance configuration data and online help text as well as assistance control commands. The device 110 provides the logic, which interprets the assistance configuration data and the assistance control commands and displays the online help text, information or functions to the user. The device 110 may be implemented by using Java using the Java Swing class library. This library is the standard for GUI (Graphical User Interface) application development and part of the Java JDK (Java Development Kit).

In order to display help information or application enhancements and to intercept the users interaction with the application, the device registers with the event loop unit 142. By this means the device 110 is notified of each input and output event initiated by the user or the application 120 on the screen. Thus, it can react on user action or on visible events launched by the computer system the application is running on as well as on the application's output.

When adapting the device 110 to different other applications, either new or existing ones, only the data stored in the configuration container 156 and the information container 158 needs to be amended. The user or technical author may provide a set of, e.g., HTML (Hypertext Markup Language) files and/or XML (Extensible Markup Language) files. The HTML files make available the online help text and the assistance control commands, which the user or the application may activate in order to trigger active assistance as described above, also referred to as ‘active help.’

The expressions “active assistance” and “active help” are just different names for controlling the application 120.

Assistance control commands may be embedded in online help text pages that get composed by the presentation unit 154. Hence, the assistance control commands could be visible, i.e., a visible representation of those commands may exist. Consequently, the user may decide whether or not to trigger the commands execution. Alternatively, the assistance control commands may be invisible and get automatically executed when the surrounding help page is displayed.

The device 110 is further configured to be activated by the application 120, i.e., when a user interaction with the application 120 is defined in the assistance configuration data, the specified action gets performed.

The specified action as well as the assistant control commands may be displaying a so-called ‘bubble help’, i.e., a small window containing help information that is displayed in proximity with the related object on the screen 136. Similar, additional functionality can be provided for the application. Alternatively, a user-driven wizard, i.e., an interactive help utility that guides the user through a potentially complex task, the provision of input for the application, some animation or an alternative help page may be displayed in response. It should be noted that in order to decide which assistance or functional enhancement is initiated, the device retrieves information about the visible state of the application, without interference with the application code. This is realized by using the windowing unit, which provides the required information.

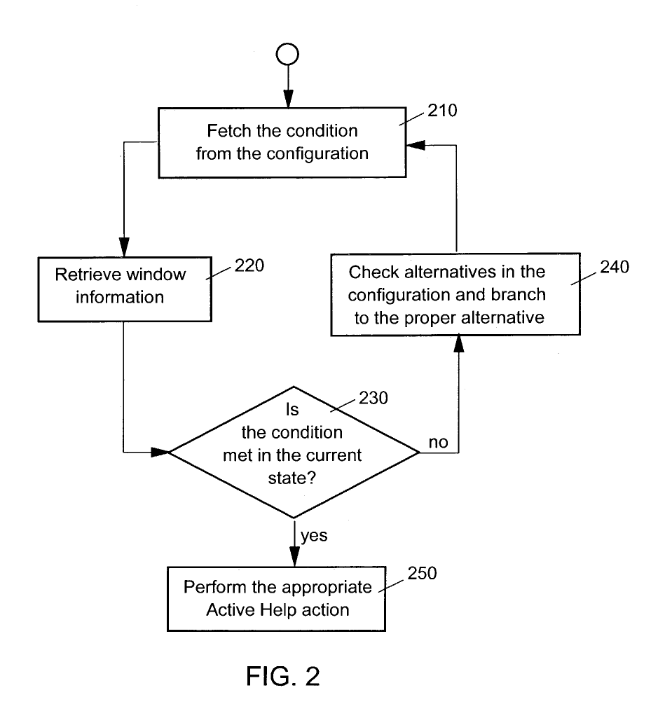

With reference now to FIG. 2, there is depicted a flow chart illustrating how an assistance action is triggered by a separate application or an assistant control command. When referring to components being present in the system in which the present invention may be implemented, the reference numerals correspond to the ones of FIG. 1.

After the device 110 has been launched, it registers with the windowing unit. From this time on all user input and application output are passed to it in form of events. Events may, e.g., be ‘right mouse click’ or ‘left mouse click’, a keystroke or any other user interaction, whereby the coordinates of the mouse cursor in the moment when the event occurs identify the referenced graphical object. Additionally, the windowing unit 130 notifies the device about automatic state transitions caused by the application. Triggered assistance control commands are also events for the device.

In detail, the following happens when an event occurs: When the logic unit 152 is notified of an event, it consults the assistance configuration data stored in the configuration container 156 in order to determine whether or not the notified event is defined in there. Finally, in case the notified event is defined in the assistance configuration data, the logic unit 152 initiates the execution of an assistance action that is associated to the event. Advantageously, the aforementioned way of initiating assistance action may be used to automatically control the external application 120, without waiting for the user to take measures. This may be combined with a watchdog timer, i.e., a device or functional unit that performs a specific operation after a certain period of time if something goes wrong within the application and the application does not recover on its own without user interaction. Therefore the present invention may advantageously be used in the field of ‘autonomic computing’ or disaster recovery.

In detail, with reference to FIG. 2, when an assistance action is triggered, the device 110 checks in the assistance configuration data which component in the application is concerned by the action and which action should be performed, if this component is existent, visible and enabled (block 210). Subsequently, window information about the concerned application component is retrieved (block 220).

In order to retrieve information about the current state of the application, the device 110, in particular the logic unit 152, first requests references to the existing windows from the windowing unit 130. Then it searches the windows for all their (sub-) components and derives a tree from this structure. Subsequently, the device 110 is able to access each component in the window and to request its properties, e.g., position, type and status, from the windowing unit. It is acknowledged that this action is completely independent from the application.

After retrieving the window information, the device determines whether or not a condition specified in the assistance configuration data is met (block 230). If no, e.g., the respective component is not existent, not visible or disabled, an alternate condition is retrieved from the assistant configuration data (block 240). If yes, the assistance action assigned to the met condition is performed, i.e., assistance action is triggered, e.g., bubble help, a user-driven wizard, an animation, input to the application or a functional enhancement of the application is provided (block 250).

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A device for providing additional functionality to a user of a separate application running on a computer system, the device comprising
a first interface for monitoring the state of said application,
a second interface for intercepting the user's input to said application,
a repository for keeping rules specifying the additional functionality to be provided to the user in response to said state of said application and said user's input,
means for triggering one of said rules, and
means for providing the additional functionality to said user as specified in the triggered rule, whereby said rule may be triggered by at least one of the group of the following input parameters, a user's input, a particular state of the application, an event triggered by said device,
means for inputting data into said separate application, whereby said data is derived from at least one input parameter from the group of, an intercepted user's input, the state of said application, an event triggered by said device.

2. The device according to claim 1, wherein said means for providing the additional functionality to said user is configured to provide data to said separate application requested from said user.

3. The device according to claim 2, wherein said means for providing the additional functionality to said user is configured to provide default values to said separate application.

4. The device according to claim 1, wherein said means for providing the additional functionality to said user is configured to extract information from said separate application for later use.

5. The device according to claim 1, wherein said means for providing the additional functionality to said user is configured to trigger an event after a predetermined amount of time.

6. The device according to claim 1, further comprising a configuration container for storing configuration data determining said rules.

7. The device according to claim 1, further comprising an information container for storing at least on of the group of, online help text to be presented to the user, control commands specifying the kind of additional functionality to be provided to said user in compliance with of one of said rules.

8. The device according to claim 1, wherein said means for inputting data into said separate application are configured to control said separate application.

9. The device according to claim 1, wherein said means for triggering one of said rules include a watchdog timer for automatically performing a predetermined action after a specified period of time.

10. A method for providing additional functionality to a user of a separate application running on a computer system, the method comprising the steps of:
monitoring the state of said application,
intercepting the user's input to said application,
triggering one of a set of predetermined rules, and
providing the additional functionality to said user as specified in the triggered rule, whereby said rule may be triggered by at least one of the following group of input parameters, a user's input, a particular state of the application, an automatically triggered event,
inputting data into said separate application, whereby said data is derived from at least one of the input parameters of the group of, intercepted user's input, the state of said application, said automatically triggered event.

11. The method according to claim 10, wherein said step of providing the additional functionality to said user includes the step of providing data to said separate application requested from said user.

12. The method according to claim 11, wherein said step of providing the additional functionality to said user includes the step of providing default values to said separate application.

13. The method according to claim 10, wherein said step of providing the additional functionality to said user includes the step of extracting information from said separate application for later use.

14. The method according to claim 10, wherein said step of providing the additional functionality to said user includes the step of triggering an event after a predetermined amount of time.

15. The method according to claim 10, further comprising the step of automatically performing a predetermined action after a specified period of time.

16. The method according to claim 10, further comprising the step of triggering a rule depending on a help text displayed to the user.

17. A computer program product stored on a computer usable medium, comprising computer readable program means for causing a computer to provide additional functionality to a user of a separate application running on the computer system, the method comprising the steps of:
monitoring the state of said application,
intercepting the user's input to said application,
triggering one of a set of predetermined rules, and
providing the additional functionality to said user as specified in the triggered rule, whereby said rule may be triggered by at least one of the following group of input parameters, a user's input, a particular state of the application, an automatically triggered event,
inputting data into said separate application, whereby said data is derived from at least one of the input parameters of the group of, intercepted user's input, the state of said application, said automatically triggered event.
